(19) United States
(12) Patent Application Publication
(10) Pub. No.: US 2024/0004095 A1
(43) Pub. Date: Jan. 4, 2024

(54) SYSTEM AND METHOD FOR MAPPING UNDERGROUND UTILITIES AND STRUCTURES

(71) Applicant: Ground Penetrating Radar Systems, Maumee, OH (US)

(72) Inventors: Mathew James Aston, Maumee, OH (US); James Robert Althauser, Maumee, OH (US); Mathew Timothy Mikolajczyk, Maumee, OH (US); Christopher Adam Polley, Maumee, OH (US); Brian James Skelding, Maumee, OH (US)

(21) Appl. No.: 18/345,710

(22) Filed: Jun. 30, 2023

Related U.S. Application Data
(60) Provisional application No. 63/367,405, filed on Jun. 30, 2022.

(51) Int. Cl. G01V 1/34

(52) U.S. Cl. CPC G01V 1/34

(57) ABSTRACT

A computing system is configured to generate a map-viewing interface including a display window visually presenting one or more display layers associated with a mapping site therein. Each of the display layers corresponds to a graphical representation of at least one structure and/or utility present at the mapping site and each of the display layers is associated with geo-positional data to establish a relative position of each of the display layers within the display window. A file tag is displayed within the display window of the map-viewing interface and is associated with a file accessible to the computing system and including data relating to one of the structures and/or utilities present at the mapping site. The file is associated with geo-positional data to establish a position of the file tag within the display window relative to each of the display layers instantaneously being visually presented within the display window.

### CROSS-REFERENCE TO RELATED APPLICATION

This patent application claims priority to U.S. Provisional Patent Application Ser. No. 63/367,405, filed on Jun. 30, 2022, the entire disclosure of which is hereby incorporated herein by reference.

### FIELD OF THE INVENTION

A system and method for mapping utilities and structures is disclosed, and more particularly, a system and method for mapping underground utilities and structures.

### BACKGROUND OF THE INVENTION

In the field of facility management and infrastructure maintenance, numerous documents play a critical role in understanding the complex network of a facility. These documents encompass a wide range of information, including blueprints, as-built drawings, construction records, and maintenance reports. However, the challenge lies in the fact that these documents are often scattered across various locations, such as filing cabinets, digital storage systems, or even different departments within an organization.

Compounding this challenge is the inherent discrepancy that can exist among these documents. Due to the evolving nature of facility infrastructure, modifications, renovations, or repairs that may have been carried out over time, differences in the content and specifications provided in each document may be evident. Consequently, facility managers and maintenance personnel face significant hurdles when attempting to ascertain the current status and configuration of a facility, particularly when multiple documents must be reviewed simultaneously.

To address these issues and provide an effective solution, it would accordingly be desirable to consolidate all facility infrastructure-related documents into a single, centralized location. By doing so, a streamlined and efficient means of accessing crucial information is offered when multiple forms of information need to be referenced in conjunction. It is further desirable to provide a system and method to more easily display the content normally found among multiple different documents simultaneously within a single location, such as within a common display where the interactions and relationships between such content may be readily ascertained.

### SUMMARY OF THE INVENTION

Concordant and congruous with the present invention, a system and method for mapping underground utilities and structures has surprisingly been discovered.

According to an embodiment of the present invention, a computing system for displaying graphic content regarding a mapping site on a user device comprises at least one processor, a communication interface communicatively coupled to the at least one processor, and a memory device storing executable code that, when executed, causes the processor to generate a map-viewing interface viewable on the user device. The map-viewing interface includes a display window visually presenting at least one of one or more display layers associated with the mapping site therein. Each of the display layers corresponds to a graphical representation of at least one structure and/or utility present at the mapping site. Each of the display layers is associated with geo-positional data to establish a relative position of each of the display layers within the display window. A file tag is displayed within the display window of the map-viewing interface. The file tag is associated with a file accessible to the computing system and including data relating to one of the structures and/or utilities present at the mapping site. The file is associated with geo-positional data to establish a position of the file tag within the display window relative to each of the display layers instantaneously being visually presented within the display window.

According to another embodiment of the present invention, a method of graphically representing a mapping site on a user device is disclosed. The method comprises the steps of: mapping at least one structure and/or utility at the mapping site via the use of at least one sensing device, the mapping step performed by one or more agents of a first entity; generating one or more first display layers, each of the first display layers corresponding to a graphical representation of at least one structure and/or utility that is derived from data acquired during the mapping step; generating one of more second display layers, each of the second display layers corresponding to a graphical representation of at least one structure and/or utility that is derived from data originating from a second entity, wherein the data originating from the second entity is acquired from a process different from the mapping step; editing one of the first display layers or one of the second display layers following a change to the mapping site, wherein the editing of each of the first display layers is restricted to be performed only by one of the agents of the first entity, and wherein the editing of each of the second display layers may be performed by one of the agents of the first entity or by the second entity; and generating a display window on the user device following the editing step, the display window visually presenting at least one of the first display layers and/or at least one of the second display layers therein to graphically represent a condition of the mapping site following the editing step.

According to yet another embodiment of the present invention, a method of assigning a work order to a service provider comprises the steps of: sending a notification to a user device of the service provider indicating the generation of the work order, the work order corresponding to a task to be performed at a mapping site, wherein the work order is associated with geo-positional data to establish a relative position of each of the display layers within the display window; generating a display window on the user device of the service provider following the sending step, the display window visually presenting at least one of one or more display layers associated with the mapping site therein, each of the display layers corresponding to a graphical representation of at least one structure and/or utility present at the mapping site, wherein each of the display layers is associated with geo-positional data to establish a relative position of each of the display layers within the display window; and tagging a position within the display window, relative to each of the display layers instantaneously visually presented therein, at which the task corresponding to the work order is to be performed based on the geo-positional data associated with the work order.

### BRIEF DESCRIPTION OF THE DRAWINGS

The above, as well as other advantages of the present invention will become readily apparent to those skilled in the art from the following detailed description of a preferred embodiment when considered in the light of the accompanying drawings.

FIG. 1 illustrates an enterprise system and environment thereof for engaging with a user during navigation of a site-mapping platform, in accordance with one embodiment of the present invention.

FIG. 2 is a flow chart summarizing a method of acquiring data regarding a mapping site to be displayed during navigation of the site-mapping platform.

FIG. 3 is an exemplary map-viewing interface of the site-mapping platform, as may be found on a display of a user device, when all display layers of the viewable mapping site are selected to be visible.

FIG. 4 shows the map-viewing interface following the deselection of at least some of the display layers of the viewable mapping site viewable in FIG. 3.

FIG. 5 is an exemplary unified view display window of the map-viewing interface, as may be found on a display of a user device, when at least one file associated with the mapping site is tagged to a specific position on the mapping site.

FIG. 6 is an exemplary file-viewing interface of the site-mapping platform.

### DETAILED DESCRIPTION OF EXEMPLARY EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

Embodiments of the present invention described herein, with reference to flowchart illustrations and/or block diagrams of methods or apparatuses (the term “apparatus” includes systems and computer program products), will be understood such that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

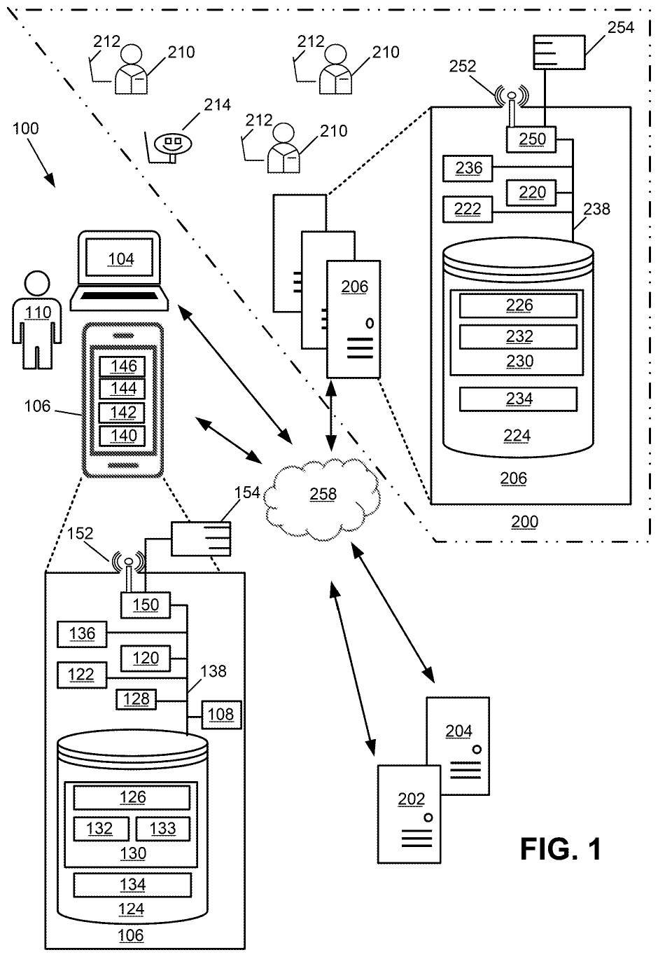

FIG. 1 illustrates a system 100 and environment thereof, according to at least one embodiment, by which a user 110 benefits through use of services and products of an enterprise system 200. The user 110 accesses services and products by use of one or more user devices, illustrated in separate examples as a computing device 104 and a mobile device 106, which may be, as non-limiting examples, a smart phone, a portable digital assistant (PDA), a pager, a mobile television, a gaming device, a laptop computer, a camera, a video recorder, an audio/video player, radio, a GPS device, or any combination of the aforementioned, or other portable device with processing and communication capabilities. In the illustrated example, the mobile device 106 is illustrated in FIG. 1 as having exemplary elements, the below descriptions of which apply as well to the computing device 104, which can be, as non-limiting examples, a desktop computer, a laptop computer, or other user-accessible computing device.

Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, iOS, Android and any other known operating system used on personal computers, central computing systems, phones, and other devices.

The user 110 can be an individual, a group, or any entity in possession of or having access to the user device, referring to either or both of the mobile device 104 and computing device 106, which may be personal or public items. Although the user 110 may be singly represented in some drawings, at least in some embodiments according to these descriptions the user 110 is one of many such that a market or community of users, consumers, customers, business entities, government entities, clubs, and groups of any size are all within the scope of these descriptions.

The user device, as illustrated with reference to the mobile device 106, includes components such as, at least one of each of a processing device 120, and a memory device 122 for processing use, such as random access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, of which the illustrated applications 132, 133 are represented as particular examples. The storage device 124 can store various other data items 134, which can include, as non-limiting examples, cached data, user files such as those for pictures, audio and/or video recordings, files downloaded or received from other devices, and other data items preferred by the user or required or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory can additionally or alternatively include an electrically erasable programmable read-only memory (EEPROM), flash memory or the like.

The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application and/or a mobile P2P payment system client application. These applications also typically provide a graphical user interface (GUI) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system client application from a mobile banking system, for example enterprise system 200, or from a distinct application server. In other embodiments, the user 110 interacts with a mobile banking system via a web browser application in addition to, or instead of, the mobile P2P payment system client application.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, user input devices and user output devices, which are operatively coupled to the processing device 120. The user output devices include a display 140 (e.g., a liquid crystal display or the like), which can be, as a non-limiting example, a touch screen of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, and/or other input device(s). The user interface may also include a camera 146, such as a digital camera.

Further non-limiting examples include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The mobile device 106 may also include a positioning device 108, which can be for example a global positioning system device (GPS) configured to be used by a positioning system to determine a location of the mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the consumer mobile device 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device. As discussed herein, the system intraconnect 138 may operatively couple various components with one another, or in other words, electrically connects those components, either directly or indirectly—by way of intermediate component(s)—with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, GPS (Global Positioning System) may be included for navigation and location-related data exchanges, ingoing and/or outgoing. Communications may also or alternatively be conducted via the connector 154 for wired connections such by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The communication interface 150 may also include a payment network interface. The payment network interface may include software, such as encryption software, and hardware, such as a modem, for communicating information to and/or from one or more devices on a network. For example, the mobile device 106 may be configured so that it can be used as a credit or debit card by, for example, wirelessly communicating account numbers or other authentication information to a terminal of the network. Such communication could be performed via transmission over a wireless communication protocol such as the Near-field communication protocol.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more users 110 in accordance with the system and method of the present invention. In some examples, the enterprise system 200 offers products, and in other examples, the enterprise system 200 offers services. Use of “service(s)” or “product(s)” thus relates to either or both in these descriptions. In non-limiting examples, services and products include information services and products, custom services and products, predefined or pre-offered services and products, consulting services and products, or advising services and products.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210, can be employed, utilized, authorized or referred by the enterprise system 200. Such human agents 210 can be, as non-limiting examples, online customer service assistants available to users 110, advisors, project managers, sales team members, technicians, and referral agents ready to route user requests and communications to preferred or particular other agents, human or virtual.

Human agents 210 may utilize agent devices 212 to serve users in their interactions to communicate and take action. The agent devices 212 can be, as non-limiting examples, computing devices, kiosks, terminals, smart devices such as phones, and devices and tools at customer service counters and windows at POS locations. In at least one example, the diagrammatic representation of the components of the user device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

From a user perspective experience, an interaction in some examples within the scope of these descriptions begins with direct or first access to one or more human agents 210 in person, by phone, or online for example via a chat session or website function or feature. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components such as, at least one of each of a processing device 220, and a memory device 222 for processing use, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data, and files such as those for user accounts, user profiles, account balances, and transaction histories, files downloaded or received from other devices, and other data items preferred by the user or required or related to any or all of the applications or programs 230.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, Near-field communication device, and other transceivers. In addition, GPS (Global Positioning System) may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing device 206, may be or include a workstation, a server, or any other suitable device, including a set of servers, a cloud-based application or system, or any other suitable system, adapted to execute, for example any suitable operating system, including Linux, UNIX, Windows, macOS, iOS, Android, and any known other operating system used on personal computer, central computing systems, phones, and other devices.

The user devices, referring to either or both of the mobile device 104 and computing device 106, the agent devices 212, and the enterprise computing system 206, which may be one or any number centrally located or distributed, are in communication through one or more networks, referenced as network 258 in FIG. 1. As used hereinafter, it is assumed that references to the enterprise system 200 performing an action related to the collection, transfer, or analysis of data is referring to an action being taken by the appropriate components of the computing system 206 of the enterprise system 200 as described herein. Similarly, references to such actions being performed by the computing devices 104, 106 or the external systems 202, 204 should be assumed to be performed by corresponding components thereof.

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations. The network 258 may be or include an enterprise or secured network, or may be implemented, at least in part, through one or more connections to the Internet. A portion of the network 258 may be a virtual private network (VPN) or an Intranet. The network 258 can include wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated environment 100. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

Two external systems 202 and 204 are expressly illustrated in FIG. 1, representing any number and variety of data sources, users, consumers, customers, business entities, banking systems, government entities, clubs, and groups of any size are all within the scope of the descriptions. In at least one example, the external systems 202 and 204 represent third party sources of data associated with a specific site or location, such as repositories of such data or entities responsible for the collection of such data.

In certain embodiments, one or more of the systems such as the user device 106, the enterprise system 200, and/or the external systems 202 and 204 are, include, or utilize virtual resources. In some cases, such virtual resources are considered cloud resources or virtual machines. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared as needed.

The present invention relates to a system and method of mapping structures and/or utilities relating to at least one geographic region, and especially underground or otherwise visually obscured structures and/or utilities associated with the corresponding geographic region. The present invention further relates to a system and method for organizing and mapping geo-located data (files) relating to the corresponding geographic region. The system and method includes the use of a software application 132 managed by the enterprise system 200, and more specifically, managed by the computing system 206 of the enterprise system 200. The software application 132 may be executable on any of the described user devices 104, 106 or agent devices 212 and provides a graphical interface for each user 110, 210 of the software application 132 to interact with data associated with the at least one geographic region. The software application 132 may include each of a map-viewing interface 501 and a file-viewing interface 502 for accessing and/or managing certain data associated with the corresponding geographic region in a desired manner, as explained in detail hereinafter.

The present invention is described hereinafter with reference to navigation of the software application 132, but it should be understood that the present invention is not limited to the use of a dedicated software application 132 executable on one of the described user devices 104, 106 or agent devices 212 in viewing or organizing the data regarding one of the mapping sites. Instead, the features described herein may similarly be accessed via a corresponding website accessible via a web browsing application executable on any of the described user devices 104, 106 or agent devices 212, wherein such a website may include the same or similar interfaces for accomplishing the same tasks as described with respect to the application 132. It is generally assumed hereinafter that the same features of the present invention may be accessible via use of the website accessible via the browser application or the direct use of the software application 132. It should also be generally understood that the website and the software application 132 may generally include the display of the same data regarding the mapping site, but may in some circumstances include a different arrangement of such data to best accommodate the configuration of the corresponding user device 104, 106, such as accommodating a specific screen configuration or a specific user input method.

The methods disclosed herein also include references to the computing system 206 responsible for communicating data necessary for the operation of the software application 132 storing data or files relating to each mapping site to the storage device 224 thereof. As utilized herein, the storage device 224 of the computing system 206 is not limited to a storage device exclusively managed by the enterprise system 200, and may instead refer to a third-party data storage device in communication with the computing system 206, or any other form of storage device 224 associated with and accessible by the computing system 206. That is, as opposed to storing all data regarding all mapping sites to a storage medium maintained directly by the enterprise system 200, the enterprise system 200 may utilize an external storage medium managed by a third-party entity for storing such data. The application 132 according to the present invention may accordingly utilize cloud-based functions to transfer data between the computing system 206 and any corresponding third-party entity, such as one of the described external systems 202, 204, during navigation of the software application 132 for sending and/or retrieving the desired data at the desired instance. It is accordingly not critical to the present invention that the acquired data be stored to a specific storage device or location, so long as the application 132 routes the desired data to the corresponding user for display thereto in accordance with the novel features of the present invention.

As used herein, each corresponding geographic region being mapped by the present method and system may correspond to any two-dimensional geographic area having a common characteristic or feature by which to identify the corresponding geographic region. For example, a geographic region may correspond to a bounded area (parcel) of real property, a contiguous set of parcels of real property, an identifiable building or structure found on one or more parcels of real property, a unit or subunit of a building or structure, or a campus/facility comprising a plurality of contiguous buildings, structures, or the like, as non-limiting examples. Each independent geographic region may alternatively be referred to as a “mapping site” hereinafter, which collectively refers to the geographic features, structures, and/or utilities found within a three-dimensional space bounded by a two-dimensional perimeter of the geographic region, with the space extending vertically into and away from a ground surface of the geographic region. Each mapping site may accordingly include any identifiable structural features disposed both above and below the ground surface within the boundary defined by the perimeter of the geographic region.

Some mapping sites may further be divisible into sub-sites that may be referenced separately or independently when data regarding the corresponding mapping site is displayed to a user of the software application 132 via the map-viewing interface 501 and/or the file-viewing interface 502. For example, a mapping site provided as a campus or facility having multiple different buildings may include each of the buildings being identified as a sub-site of the mapping site. As another example, different systems or other structural features associated with the mapping site may be identified as separate sub-sites of the mapping site, such as dividing a system of water related utilities/structures from a system of electrical related utilities/structures as separate sub-sites of the mapping site, thereby providing an additional layer of differentiation between systems or structures of a common mapping site.

Each mapping site described herein may accordingly be bound by a perimeter that can be defined in terms of the coordinates along two perpendicular axes, such as utilizing the longitude and latitude coordinates of the geographic coordinate system (CGS) in defining the perimeter of the mapping site when viewing a typical overhead map perspective thereof. Each feature disclosed within this perimeter can also be described and referenced in terms of such coordinates along the two perpendicular axes (longitude and latitude). In some instances, where a depth or height of certain structural features is known, it may further be possible to define or describe certain features within the mapping site in terms of a third axis extending in the vertical (height/depth) direction perpendicular to the longitude and latitude directions. Each sub-site described above may similarly be defined or described in terms of such axes, whether two-dimensional or three-dimensional.

Each mapping site and/or sub-site may be described by a set of nominal coordinates corresponding to a point position within the respective mapping site or sub-site at which the respective mapping site or sub-site is identifiable when utilizing the map-viewing interface 501 and/or the file-viewing interface 502 of the application 132. For example, a mapping site corresponding to a parcel of property covering a two-dimensional area may include a nominal point position at a two-dimensional (longitude and latitude) center of the area bound by the perimeter of the mapping site, and the coordinates of this nominal point position of the mapping site may be utilized by the map-viewing interface 501 in identifying a point position of the mapping site when viewing an overhead perspective thereof, or may be utilized by the file-viewing interface 502 in referencing a point position of the mapping site when identifying the file content associated with the mapping site. The nominal point position may correspond to any position within the mapping site, as desired, in addition to the example of the center point. In addition to identifying a general position of the corresponding mapping site and/or sub-site, the nominal point position may be utilized by the application 132 when certain data associated with the corresponding mapping site and/or sub-site is not readily associated with a specific position within the mapping site and/or sub-site, and is therefore more easily associated with the mapping site and/or sub-site in a more general sense. For example, a process (such as general cleaning or maintenance) occurring with respect to an entirety of the corresponding mapping site or sub-site may be associated with the nominal point position of the corresponding mapping site or sub-site as opposed to a specific location therein, whereas a process (such as a repair) occurring at a specific location within the mapping site or sub-site may be associated with that specific position instead of the nominal point position of the corresponding mapping site or sub-site.

The enterprise system 200 associated with the management of the software application 132 may be directly or indirectly associated with the collection of the data associated with the at least one mapping site that is in turn utilized in generating any graphical representations or renderings of any associated utilities and/or structures of the mapping site, and/or for generating any documents or related files associated with the construction, repair, maintenance, and/or alteration of the associated utilities and/or structures of the mapping site. For example, the enterprise system 200 may refer to an entity employing or otherwise having a contractual arrangement with one or more agents 210 that acquire at least some of the data associated with the corresponding mapping site via direct engagement with the mapping site, wherein such direct engagement refers to the one or more agents 210 performing on-site measuring, sensing, or imaging processes with respect to the mapping site for acquiring the necessary mapping site related data.

In some circumstances, such as when acquiring certain forms of data regarding the corresponding mapping site, only approved agents 210, such as direct employees of the enterprise system 200 or closely affiliated contractors/subcontractors of the enterprise system 200, may be able to acquire/edit/update certain types of data regarding the mapping site to ensure that such data is accurately attained and properly maintained in accordance with the terms and conditions of the enterprise system 200. As utilized herein, the approved agent 210 refers to a person or entity determined by the enterprise system 200 to have the training, expertise, and authority to collect and store such data associated with the mapping site, on behalf of the enterprise system 200 and in accordance with the standards and conditions established by the enterprise system 200, during the direct engagement of the approved agent 210 with the corresponding mapping site. The approved agent 210 accordingly refers to an agent that the enterprise system 200 entrusts in properly acquiring the necessary data such that the acquired data is reliably representative of an instantaneous state or condition of any associated utilities and/or structures associated with the mapping site, which may alternatively be referred to as the current “as-built” state or condition of the utilities and/or structures of the mapping site.

The application 132 may be accessed and utilized by any number of different parties in need of access to the data regarding the desired mapping site. One party that may act as the user of the application 132 may be a customer 110 of the enterprise system 200 that has requested the services of the enterprise system 200 in directly and/or indirectly acquiring the mapping site related data necessary for generating the map-viewing interface 501 and the file-viewing interface 502 of the application 132 in accordance with the present disclosure. The customer 110 may refer to the person or entity owning, managing, or otherwise having authority over the mapping site for which the mapping and file organizing services are requested, or to an authorized agent of such a person or entity having the authority to act in such a capacity. In some embodiments, a customer 110 may be associated with multiple distinct mapping sites that have been provided the services of the enterprise system 200 such that the customer 110 may be able to view data associated with multiple different mapping sites contemporaneously via use of the application 132, as described in greater detail hereinafter. The customer 110 may be provided certain privileges to view and/or edit/update certain forms of data associated with each of the mapping sites for which the customer 110 has management authority. The customer 110 may access the application 132 while utilizing one of the user devices 104, 106 as described herein.

Another party that may utilize the application 132 may be one of the agents 210 of the enterprise system 200. In some circumstances, the agent 210 may be an administrator of the enterprise system 200 having access to the data associated with each respective mapping site accessible via use of the application 132. In other circumstances, the agent 210 may refer to a technician, or the like, acting as an approved agent 210 of the enterprise system 200, wherein the approved agent 210 may have access to the data regarding any mapping sites associated with the products or services that may be supplied by the approved agent 210 in carrying out the objectives of the enterprise system 200. In other words, the approved agent 210 may have access to certain data regarding any mapping sites for which the approved agent 210 has acquired data relating to the mapping site or has been requested to perform the acquisition of such data relating to the mapping site at a future instance. The agent 210 may access the application 132 while utilizing one of the agent devices 212. As explained above, the user devices 104, 106 and the agent devices 212 may refer to the same types or forms of computing devices having the same capabilities, wherein the differentiation between the user devices 104, 106 and the agent devices 212 may refer only to the party instantaneously utilizing such a device, and not to any inherent difference in capabilities between said devices 104, 106, 212.

Yet another party that may have access to the application 132 may include a third-party service/product provider that may desire access to the capabilities of the application 132 for acquiring certain data regarding the mapping site. Such a third-party provider may refer to a contractor or subcontractor that has been assigned a task with respect to a structure and/or utility of the corresponding mapping site wherein access to the data accessible via the application 132 may be beneficial. For example, where a contractor has been contracted by the customer 110 and/or the enterprise system 200 to perform a task with respect to an underground water line passing through the mapping site, the contractor may be given permissions to establish an account with the application 132 in order to access the necessary data regarding the mapping site and any relevant underground structures to aid in properly and efficiently performing the contracted task. As explained hereinafter, the third-party provider may in some instances perform similar tasks as the customer 110 and/or the approved agent 210 with respect to a mapping site, but may not include the same permissions or authorities regarding the input, analysis, editing, or removal of certain types of data regarding the mapping site as does the customer 110 or one of the approved agents 210 of the enterprise system 200.

The acquisition of data relating to the mapping site may include one of the agents 210 utilizing various different sensing devices for acquiring data associated with the generation of multi-dimensional graphic representations or renderings (2-D or 3-D images, schematics, models, or equivalents) of the mapping site and any associated utilities and/or structures contained thereon. Such data acquisition may include the agent 210 taking photographic images, videos, or three-dimensional scans of visually perceptible aspects of the mapping site and/or may include the agent 210 utilizing penetrative sensing devices for rendering a multi-dimensional (2-D or 3-D) representation of an otherwise non-visually perceptible aspect of the mapping site, such as may occur via the use of ground-penetrating radar-based devices for mapping underground utilities and/or structures.

Each mapping site may be imaged/mapped according to any of a number of different imaging/mapping processes to result in the generation of a graphical representation or rendering of any associated utilities and/or structures of the corresponding mapping site. Such processes may include the use of a drone and associated camera/imaging device for producing aerial imagery of the mapping site, the use of a three-dimensional scanning device for producing a three-dimensional model of the visually perceptible structure of the mapping site (such as a point-cloud based model of the mapping site generated via a 3-D laser scanning process), or the use of one of the penetrative sensing devices for creating a two or three-dimensional graphical representation of a visually non-perceptible structure of the mapping site. It should be apparent that any three-dimensionally produced graphical representation or rendering may also be reproduced as a two-dimensional projection, as a two-dimensional cross-section, a two-dimensional schematic or symbol, or as an alternative two-dimensional representation or rendering when recreating or converting such a three-dimensional graphical representation or rendering into a two-dimensional format, such as when overlaying any such graphical representation or rendering relative to an overhead two-dimensional view of the geographic region corresponding to the mapping site, or when overlaying such a graphical representation or rendering relative to an elevational two-dimensional view of the mapping site showing structural features at a depth/height relative to a ground surface, as non-limiting examples. Any such two or three-dimensional graphical representations or renderings of any geographic features, structures, utilities, or the like may accordingly be able to be converted into a format for display relative to other geographic features, structures, utilities, or the like of the corresponding mapping site when generating a two or three-dimensional map or similar graphical representation or rendering of the mapping site, as displayed during navigation of the map-viewing interface 501.

The agent device 212 associated with each agent 210 may be configured to interface or communicate, whether directly or indirectly, with each of the necessary imaging/mapping devices for acquiring the collected data regarding the mapping site. The data may be collected in a raw format to be sorted/analyzed subsequently or may be organized as standard file formats or the like, depending on the circumstances. In any event, the agent 210 and the agent device 212 are configured to have the capability to communicate the data collected during the engagement with the mapping site in a manner wherein such data is accessible during the navigation of the application 132 according to the method of the present invention. That is, the acquired mapping site related data may be organized in the necessary format and then stored to the storage device 224 associated with the computing system 206 and the software application 132 via action taken by the approved agent 210 following completion of any necessary engagements with the mapping site.

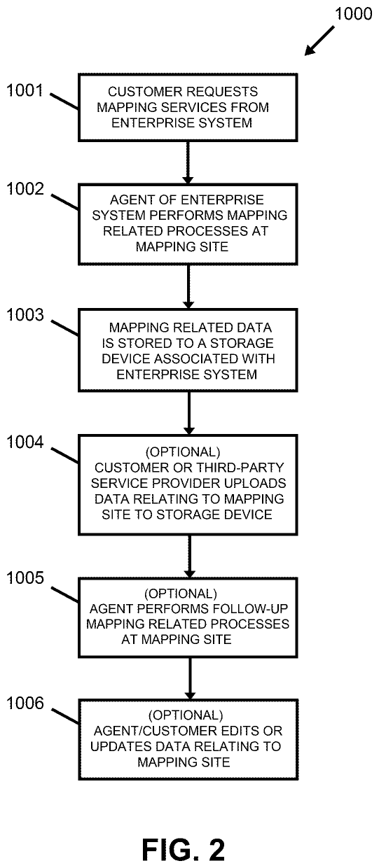

Referring now to FIG. 2, a representative method 1000 of acquiring data regarding a mapping site, to be viewable or navigable via use of the map-viewing interface 501 and/or the file-viewing interface 502 of the software application 132, is disclosed. The method 1000 includes a first step 1001 wherein a customer 110 of the enterprise system 200 engages the enterprise system 200 and requests that the enterprise system 200 performs mapping and/or file organizing tasks with respect to an identified mapping site associated with the customer 110. In a step 1002, the enterprise system 200 sends an approved agent 210 to the actual mapping site and the approved agent 210 performs the imaging/sensing/measuring/mapping based processes necessary for collecting the desired data for identifying structures and/or utilities present at the mapping site, including structures and/or utilities found both above and below ground. In a step 1003, the approved agent 210, via a corresponding agent device 212, uploads the data acquired during the direct engagement with the mapping site for storage to the storage device 224 associated with the computing system 206 and the software application 132.

The method 1000 may further include an optional step 1004 of uploading customer or third-party provided data to the storage device 224 associated (directly or indirectly) with the computing system 206 to be accessible during navigation of the software application 132. The customer or third-party provided data may correspond to any mapping related data, documents, files, or the like that relate to the mapping site that have not been acquired via a direct engagement with the mapping site by an approved agent 210 of the enterprise system 200. Such customer or third-party provided data may include data previously acquired regarding the mapping site by the customer 110 or a third-party employed by the customer 110, or may be derived from data that is readily available and accessible regarding the mapping site, such as publicly available data.

The customer 110 and/or associated third-party service provider may upload any of a variety of different forms of data to be accessible via navigation of the software application 132. The data may be in the form of files or documents pertaining to the management of the mapping site, including documents or files relating to the construction, maintenance, and/or servicing of any structures and/or utilities associated with the mapping site. For example, documents or files such as blue-prints, as-built drawings, prior work orders, prior site reports, insurance documents, documents relating to permitting or other regulatory standards, contracts, maintenance logs, images/videos documenting a state or condition of a structure and/or utility or a repair thereof, or the like may be uploaded and associated with the corresponding mapping site such that these documents or files are available for review by a customer 110 and/or agent 210 during navigation of the software application 132.

The customer 110 or associated third party may also upload documents or files that may be utilized in producing a graphical representation or rendering of a structure and/or utility found on the mapping site as may be viewable during use of the map-viewing interface 501 of the software application 132. For example, the customer 110 or associated third party may upload data or files corresponding to two-dimensional images or three-dimensional objects that may be viewable relative to the mapping site, such as customer-provided aerial images of the mapping site or customer-provided CAD files pertaining to three-dimensional structures and/or utilities found at the mapping site. As yet another example, the customer 110 or associated third party may choose to upload data or file content from other commercially available packages such as Google Earth, AutoDesk, and/or ArcGIS, as non-limiting examples. Such commercially available packages may also be utilized by the enterprise system 200 when acquiring the data regarding the mapping site without departing from the scope of the present invention.

The method 1000 may further include an optional step 1005 wherein the enterprise system 200 utilizes the approved agent 210 to perform additional or repeat imagining/measuring/sensing to provide updated data regarding the mapping site, wherein it is assumed that the step 1005 occurs following a change to the configuration of the mapping site relative to that discovered during the step 1002 or following the passage of time wherein a change may be reasonably discovered between the results of the steps 1002 and 1005. Such new or replacement data acquired during the step 1005 may be utilized in place of the data acquired during the step 1002 to establish the data acquired during step 1005 as the current “as-built” state or condition of the mapping site. The step 1005 may further include the approved agent 210, via a corresponding agent device 212, uploading the data acquired during the direct re-engagement with the mapping site to the storage device 224 associated with the computing system 206 and the software application 132.

An additional optional step 1006 of the method 1000 may include any of the customer 110, the agent 210, or an associated third-party (having the necessary permissions) editing or updating data that has been previously acquired with respect to the mapping site, wherein such edited or updated data is once again stored to the storage device 224 associated with the computing system 206 and the software application 132. For example, graphical representations or renderings of certain utilities of the mapping site, such as schematic depictions of water lines, electrical lines, etc., may be edited or updated when various changes are made thereto, such as the addition or removal of an above-ground valve or of an electrical junction, as non-limiting examples. The optional steps 1004, 1005, and 1006 may accordingly be utilized in ensuring that the data associated with the mapping site is as complete and up-to-date as possible via the ability to upload additional content and the ability to edit and/or replace already uploaded content when changes occur with respect to the mapping site.

The application 132 may include a beneficial feature wherein the editing or recordation of the acquired data during any of steps 1002, 1004, 1005, or 1006 may include the ability to record such edited or new data to the corresponding user device 104, 106, 212 in the absence of an internet connection to account for situations where an internet connection (including cellular service) is not readily available at certain mapping sites. The recorded data may then be uploaded to the storage device 224 associated with the application 132 whenever an internet connection has been established at a future instance by the corresponding user device 104, 106, 212.

The presently disclosed system and method includes the data acquired regarding the mapping site that is viewable via the map-viewing interface 501, such as any uploaded two or three-dimensional graphical representations or renderings of the mapping site, being associated with geo-positional data that establishes a geographic position (such as the GCS coordinates) and corresponding orientation of each such graphical representation or rendering such that different graphical representations or renderings may be displayed relative to each other during navigation of the map-viewing interface 501 while maintaining the proper spatial relationships therebetween. The collection of such geo-positional data may occur during the process of acquiring such data, such as by a sensing device having GPS capabilities that are utilized in associating a sensed position at the mapping site with a corresponding set of GCS coordinates. However, each graphical representation or rendering may be associated with the appropriate GCS coordinates according to any method while remaining within the scope of the present invention, including determining the necessary coordinates and orientation corresponding to the graphical representation or rendering following the creation thereof in a post-editing process, or the like. The geo-positional data may be associated with any of the different forms of data that have been described as being acquirable with respect to the mapping site, whether derived from an approved agent 210, a customer 110, or an associated third-party service provider. The use of graphical representations or renderings that reference such geo-positional data results in the ability to easily overlay multiple different representations or renderings over one another for providing a consistent and accurate view of the configuration of the corresponding geographic features, structures, and/or utilities with respect to a given perspective, such as the standard overhead plan view typically associated with a map.

The present invention is not limited to the use of geo-positional data in identifying the correct configuration and relative positioning of geographic features, structures, and/or utilities for providing a graphical interpretation thereof, but may also be utilized in identifying an association between any of the other types of data described herein and a general or specific position within the mapping site. The data acquired with respect to the mapping site that is accessible via the application 132 may include files corresponding to documents associated with the mapping site, such as work orders, contracts, invoices, part requests, maintenance reports, etc., which may be able to be associated with the mapping site or a specific position within the mapping site. Each such form of data may be “tagged” with reference to the earlier described nominal point position of the mapping site (or a corresponding sub-site) where a specific position is not defined, or may be “tagged” with reference to a specific position, such as a specific set of GCS coordinates within the mapping site, that corresponds directly to the contents of the form of data tagged thereto. For example, where a specific valve is in need of servicing along a water line at a known position within the mapping site, documents such as work orders, invoices, post-work images showing the work performed, or the like related to the servicing of the valve may be tagged to the GCS position of the specific valve in question. Other files, such as files corresponding to two or three-dimensional models relating to a component or structure found at the mapping site, may also be tagged with regards to a nominal or specific position within the mapping site corresponding to the modeled component or structure. For example, a three-dimensional CAD model of a component found within the mapping site may be tagged to the installed position within the mapping site to associate the CAD model of the component with the installed position thereof. It should be understood that substantially any form of data or file type allowing for access to and/or visualization of information directly relating to the mapping site may be utilized in conjunction with the application 132 in accordance with the present disclosure.

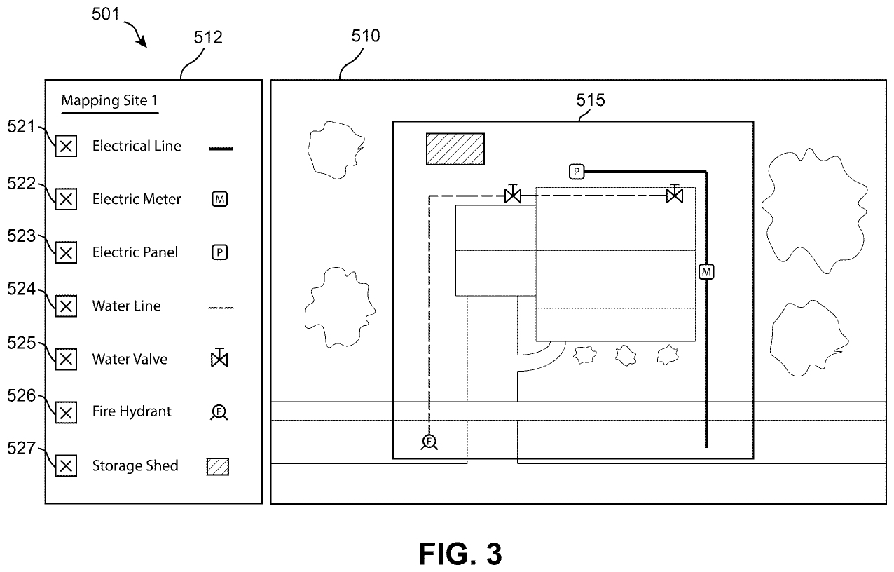

The map-viewing interface 501 of the application 132 is described in greater-detail hereinafter. FIGS. 3-5 illustrate several exemplary depictions of the map-viewing interface 501 in accordance with the types and forms of data described as being displayable via the map-viewing interface 501 following the acquisition of such data via the steps described with reference to the method 1000. Each depiction may correspond to the appearance of a corresponding screen (or portion thereof) associated with any of the described devices 104, 106, 212 as would appear to a customer 110 or agent 210 during navigation of the application 132 and utilization of the map-viewing interface 501.

The map-viewing interface 501 includes a unified view display window 510 configured to display one or more display layers associated with a corresponding mapping site. Each of the display layers may refer to at least one of the two-dimensional representations or renderings of data relating to one or more geographic features, structures, and/or utilities found within the mapping site, and each of the display layers may include geo-positional data for establishing a position and orientation of each corresponding two-dimensional representation or rendering relative to any other instantaneously displayed graphical representations or renderings. In some embodiments, at least some of the display layers correspond to photographs or computer generated images of aspects of the mapping site while other layers may correspond to schematic depictions of aspects of the mapping site, such as utilizing lines, shapes, icons, symbols, or the like to identify certain features of a structure or system of utilities. Such schematic representations may include the use of different line thicknesses, colors, broken-line patterns, or the like to differentiate between different structural features or different utility systems. For example, the components schematically represented as forming a portion of a gas system of the mapping site may be represented in a different color from those components schematically represented as forming a portion of an electrical system of the mapping site, thereby easily differentiating utility systems displayed within the unified view display window 510. At least one of the display layers may include an image corresponding to an aerial or satellite view of the mapping site to provide visual reference for any schematic representations overlaid relative to the image.

Each of the display layers may correspond to a graphical representation of one or more different geographic features, structural features, or utility-related systems. Specifically, each layer may be associated with a single component/feature/structure/etc., or each layer may be associated with multiple different components/features/structures/etc. shown in combination. Each layer may include any combination of visual data corresponding to the appearance or configuration of any combination of said components/features/structures/etc. When the unified view display window 510 includes the display of multiple display layers contemporaneously, certain visual features of the layers may overlap or cross over one another. Such features may be shown in partial transparency where overlapping or may include a preference of which display layers are arranged to appear in front or behind other instantaneously viewable display layers, as non-limiting examples of differentiating different graphical representations or renderings from one another. In some circumstances, an arrangement of the display layers may be based on known depths/heights of the mapped components/features/structures/etc., wherein the graphical representations or renderings overlap each other based on the relative vertical positions thereof.

Each respective display layer may originate from any of the sources of the mapping site related data described with reference to the method 1000 herein. That is, at least one display layer always originates from the data acquisition occurring via direct engagement of one or more approved agents 210 of the enterprise system 200 with the mapping site as described with reference to either of steps 1002 or 1006, and may further include optional and additional display layers originating from the customer 110 or a third-party source. A customer 110 may accordingly add as many display layers for viewing within the unified view display window 510 as desired, wherein each display layer may correspond to some form of graphical representation or rendering or geo-positioned data. Any approved third-party service provider, such as a contractor or sub-contractor assigned to perform work at the mapping site and having access to the application 132, may also potentially add and associate any display layers with the mapping site for viewing within the unified view display window 510, when so allowed.

One advantage of the present method and system lies in the manner in which the application 132 allows for a differentiation of the editing or replacement options associated with different display layers viewable within the unified view display window 510 during use of the map-viewing interface 501. That is, the present system and method allows for the enterprise system 200 to determine which display layers are considered to be editable display layers having content that is able to be edited, replaced, or removed by the customer 110 or an associated third-party service provider, and which display layers are considered to be restricted display layers having content that is only able to be edited, replaced, or removed by an agent 210 of the enterprise system 200.

The division of the display layers into restricted display layers and editable display layers may be based on any number or combination of criteria established by the enterprise system 200 for ensuring that certain data viewable during navigation of the map-viewing interface 501 is current and accurate. The customer 110 and/or an approved third-party service provider may be restricted from editing, replacing, or removing such restricted display layers to prevent an incidence of improper data being communicated to the customer 110 or the agent 210 during the viewing of such restricted display layers, such as preventing an incidental or accidental alteration to visual data corresponding to important features or structures found within the mapping site. As mentioned above, the approved agent 210 may utilize specific imaging/measuring/sensing/mapping devices and may include specialized training for ensuring that the data acquired during steps 1002 or 1005 described above is accurate and reliable in establishing the configuration of any features, structures, utilities, or related systems found within the mapping site, hence it is important to limit access to such restricted display layers to ensure that appropriate standards for accuracy and reliability are attained.

The division of the display layers into editable and restricted categories may be based on one or more of the following conditions, whether considered alone or in combination. As one condition, a display layer associated with displaying data acquired during a direct engagement of the approved agent 210 with the mapping site may be considered to be restricted to ensure that only the approved agent 210 (or another similar qualified agent 210) can edit, replace, or remove such data. As another condition, a display layer associated with displaying data associated with visually imperceptible features, structures, or utilities, such as those found underground or within a structure, may be restricted. In other circumstances, any display layer based on data acquired using a penetrative sensing device, such as ground-penetrating radar, may be restricted. More generally, any display layer corresponding to a graphical representation or rendering of a permanent or semi-permanent feature of the mapping site may be restricted, wherein such a permanent or semi-permanent feature may refer to a feature of the mapping site that is not easily accessed or altered absent the destruction, disassembly, or deformation of some aspect of the mapping site.

Referring back to FIG. 3, in addition to the unified view display window 510, the map-viewing interface 501 may further include a display layer selection window 512. The display layer selection window 512 may include a listing of each display layer that has been generated with respect to the mapping site being viewed, and provides the option to select (via a marking box) which of the generated display layers is instantaneously viewable within the unified view display window 510. The current user 110, 210 of the map-viewing interface 501 may accordingly toggle which of the display layers is viewable to create a visualization of any combination of customer 110 or agent 210 generated display layers. In the present embodiment, the display layer selection window 512 further acts as a legend for determining the appearance of each graphical representation or rendering as found within the unified view display window 510, which includes schematic representations in the present example.

The unified view display window 510 of the present example illustrates a perimeter 515 of an exemplary mapping site having various different structures and utilities mapped according to different display layers of the mapping site. In the present example, each different type of graphical representation or rendering of a feature/structure/utility is associated with a distinct display layer, but it should be understood that multiple different features/structures/utilities may be displayed simultaneously within a single display layer while remaining within the scope of the present invention. The display layers includes a first display layer 521 corresponding to an electrical line, a second display layer 522 corresponding to an electric meter, a third display layer 523 corresponding to an electric panel, a fourth display layer 524 corresponding to a water line, a fifth display layer 525 corresponding to a water valve, a sixth display layer 526 corresponding to a fire hydrant, and a seventh display layer 527 corresponding to the structure of a storage shed.

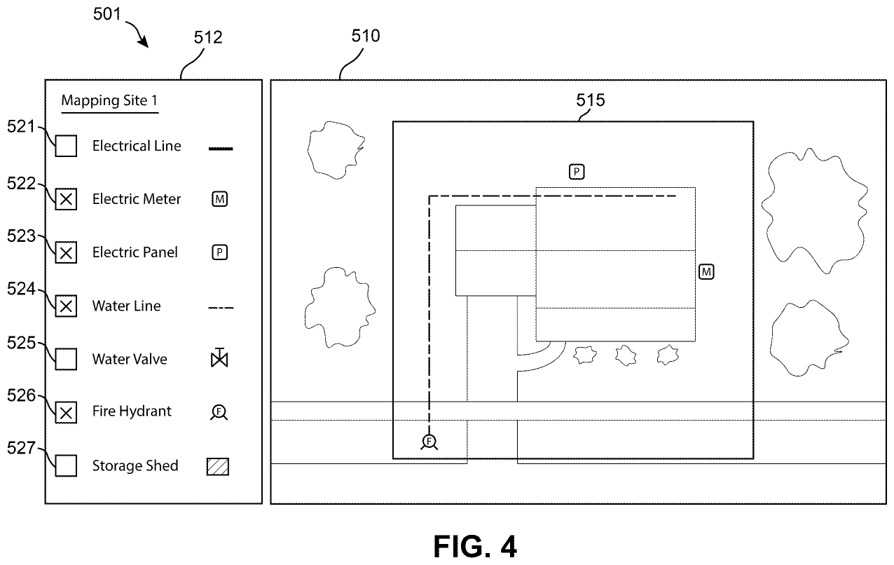

FIG. 3 includes all of the display layers 521, 522, 523, 524, 525, 526, 527 being selected (marked) such that the unified view display window 510 includes a visualization of each graphical representation or rendering associated of all available display layers 521, 522, 523, 524, 525, 526, 527 simultaneously. In contrast, FIG. 4 includes the de-selection of the display layers 521, 525, and 527, thereby removing the visualization of the electrical lines, the water valves, and the storage shed to illustrate the method of operation of the present invention.

In the example shown in FIGS. 3 and 4, the different display layers 521, 522, 523, 524, 525, 526, 527 may be categorized as follows to illustrate one possible differentiation between editable and restricted display layers according to a non-limiting example. The first and fourth display layers 521, 524 corresponding to underground utility lines may be designated by the enterprise system 200 as restricted display layers following the mapping thereof by an approved agent 210, thereby restricting access to the customer 110 or other unapproved third-parties in editing, replacing, or removing the display layers 521, 524. In contrast, the display layers 522, 523, 525, 526 corresponding to components found along such water/electrical lines may be editable display layers that are not so restricted. Such a categorization indicates that the customer 110 or an associated third-party may edit these display layers to reflect changes to these specific components reflected therein. For example, the editable nature of the layers 522, 523, 525, 526 may include the customer 110 or associated third-party removing one of the water valves of the fifth display layer 525, or replacing one of the water valves with another component, following completion of a task associated with the corresponding water valve. The customer 110 may accordingly edit those aspects of the mapping site that are not restricted by the enterprise system 200 to result in the customer 110 having the most up-to-date representation of the mapping site as possible.

The seventh display layer 527 may correspond to an example of a customer-provided display layer that is automatically designated as editable due to the origin thereof. The present example includes the storage shed as a two-dimensional overhead representation of a customer-provided three-dimensional CAD model of the storage shed. The content of any such customer-provided display layer may be freely edited, replaced, or removed by the customer 110.

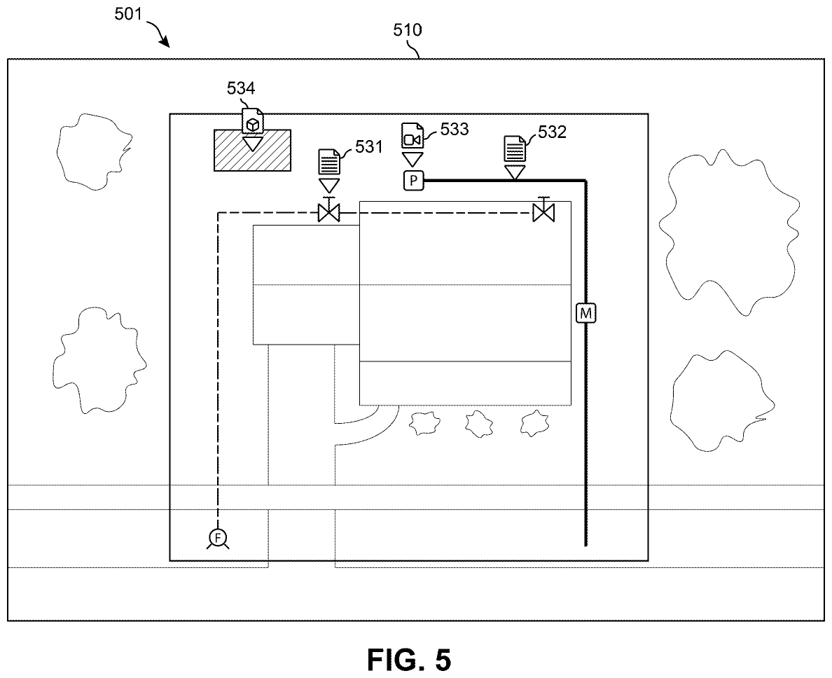

Referring now to FIG. 5, the unified view display window 510 is shown as including a plurality of file tags 531, 532, 533, 534 visualized thereon relative to the mapping site. Each of the file tags 531, 532, 533, 534 is utilized when referencing one of the previously described forms of data (files) having geo-positional data associated therewith such that the corresponding data (file) may be associated with and visualized relative to a specific geo-position within the viewable mapping site, which may directly corresponding to a specific sub-site, feature, structure, or utility of the mapping site. The file tags 531, 532, 533, 534 may be associated with the mapping site and added to the unified viewing display window 510 by any authorized user 110, 210 of the software application 132. Specifically, any files that have been uploaded to the application 132 for storage to the storage device 224 and then associated with the account corresponding to the desired mapping site may be available for selection to be tagged by a corresponding user 110, 210 of the application 132, such as by check-box in similar fashion to the illustrated display layer selection window 512. Alternatively, each of the files that has been associated with the mapping site while also associated with the necessary geo-positional data may be available as a separate display layer for selection within the display layer selection window 512 to show or hide the tagged content. Any files associated with the mapping site, but lacking specific positional data, may be associated generally with the mapping site and may be visualized according to the nominal point position of the mapping site described above.

Accordingly to one example, the file tag 531 may relate to a document file regarding an invoice for a prior repair to the identified water valve, the file tag 532 may relate to a document file regarding a work order to perform a task at the identified position along the electrical line, the file tag 533 may relate to a video file recorded by a technician when performing a task with respect to the identified electrical panel, and the file tag 534 may relate to the three-dimensional CAD file from which the graphical representation of the storage shed has been derived. The application 132 may include the ability to reroute the user 110, 210 thereof to view or interact with the tagged file via an interaction of the user 110, 210 with the corresponding file tag 531, 532, 533, 534 during navigation of the map-viewing interface 501, or to reroute the user 110, 210 to the file-viewing interface 502 in order to provide additional options to the user 110, 210 regarding actions that can be taken with respect to the selected file. Alternatively, an interaction with the file tag may directly provide options to the user 110, 210 during navigation of the map-viewing interface 501 regarding actions that can be taken with respect to the selected file. For example, such actions may include the ability of the instantaneous user 110, 210 to send or share the selected file in question to another user 110, 210 of the application 132 or to download the file in question to the instantaneous user device 104, 106, 212.

The map-viewing interface 501 may include the ability for the user of the application 132 to alter the geographic area shown within the unified view display window 510 in traditional fashion for altering the view of the desired mapping site. For example, the viewable geographic area within the unified view display window 510 may be translated in any direction to result in different areas of the mapping site being viewable or may be zoomed in or out to result in more or less of the mapping site being instantaneously viewable while altering the scale of any graphical representations or renderings shown in the corresponding display layers.

In some circumstances, the customer 110, the agent 210, or an associated third-party service provider may have access to multiple different mapping sites such that more than one mapping site may be viewable within the unified view display window 510 while altering the geographic area instantaneously viewable therein. With respect to a customer 110, such a circumstance may occur where the customer 110 manages or maintains multiple different mapping sites that have been mapped by the enterprise system 200 and associated with the map-viewing interface 501. With respect to an agent 210, such a circumstance may occur when the agent 210 has previously or is currently assigned to perform tasks at multiple different mapping sites. With respect to a third-party service provider, such as a contractor, such a circumstance may similarly occur when the service provider has previously or is currently assigned to perform tasks at multiple different mapping sites. In any event, the unified view display window 510 may include a feature wherein a level of detail shown within one or more of the display layers varies based on the zoom adjustment of the unified view display window 510. That is, certain features may be illustrated only as single point positions or tags when sufficiently zoomed out such that details of the features in question cannot be adequately rendered on the screen of the corresponding user device 104, 106, 212, and such features may then progressively gain more detail in achieving an appearance of the actual configuration thereof. This feature allows a user 110, 210 navigating multiple different mapping sites to zoom out and easily discover the point position of tagged position of each of the multiple mapping sites before zooming in towards one or more desired mapping sites for revealing the desired level of detail thereof.

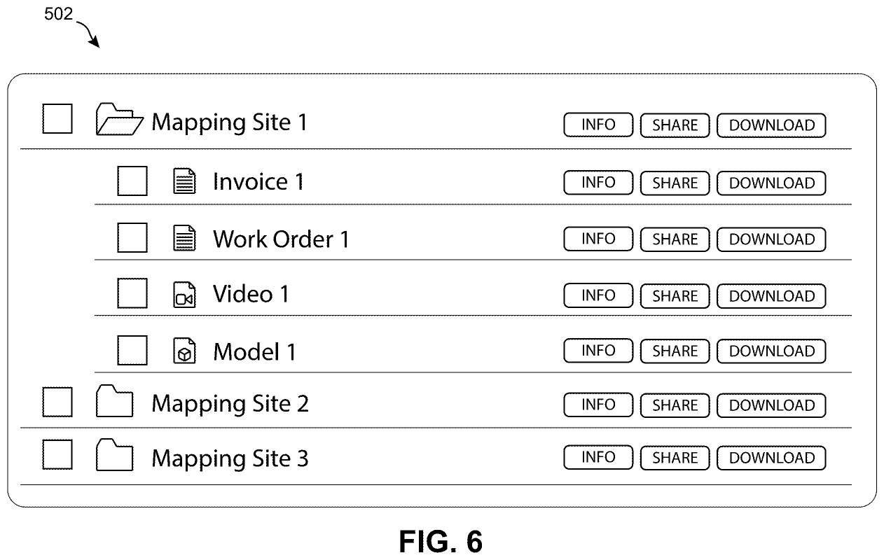

Referring now to FIG. 6, a simplified version of the file-viewing interface 502 is shown for illustrating the basic concepts of the present invention. The file-viewing interface 502 allows the corresponding user 110, 210 to navigate all different files associated with all different mapping sites that the user 110, 210 is associated with or has permissions to access. The file-viewing interface 502 may include the ability for the user 110, 210 to sort the files accessible to the user 110, 210 via any form of data or meta data associated with such files. The file-viewing interface 502 may include a typical folder and file format wherein each mapping site and/or sub-site corresponds to a folder and the data associated with each mapping site and/or sub-site is found as data or files contained within the corresponding folder. As one beneficial feature, the use of the application 132 as a method of organizing tasks assigned to one of the agents 210 or to an associated third-party service provider may include the ability to include data with respect to certain files that identifies a specific work order number, account number, or the like, thereby allowing the user 110, 210 to sort files originating from multiple different mapping sites. For example, an agent 210 may desire to view all pending work orders regarding the execution of the step 1002 described in method 1000, and may sort all accessible files to include only such pending work orders among all of the mapping sites to which the agent 210 has access to the files thereof. Each file may also include the geo-positional data to further allow for sorting of the associated data.

As shown in FIG. 6, the representative file-viewing interface 502 includes a folder for each of three different mapping sites with the contents of the folder entitled “Mapping Site 1” exposed to show each of the different files associated with the identified mapping site. In the present example, a set of files corresponding to each of the file tags 531, 531, 533, 534 shown in FIG. 5 is associated with Mapping Site 1. As shown to the right of each file and folder, the file-viewing interface 502 may include the ability to share, download, or request additional information (such as additional data or metadata) regarding each folder or file. The sharing feature may include the ability to collaborate among multiple different agents 210 or third-party service providers when performing tasks with respect to a mapping site, or to assign or reassign such tasks, as the circumstances warrant. For example, a work order file may be shared to an agent 210 or third-party service provider indicating the need for a task to be completed at the corresponding mapping site, and potentially at a specific position within said mapping site based on the presence of specific geo-positional data. The sharing of a mapping site or associated file may be associated with giving permission to the receiving party to have some level of interaction with the mapping site in accordance with the description of the present invention, such as being able to view all corresponding display layers and associated files.

The file-viewing interface 502 may include functionality to allow the user 110, 210 to view the relative position of a selected file during navigation of the file-viewing interface 502 via a redirection of the user 110, 210 to the map-viewing interface 501, wherein the unified view display window 510 may display the position of the file within the corresponding mapping site. The file-viewing interface 502 may accordingly provide an especially useful feature wherein a corresponding user 110, 210 can quickly identify the physical position to which a file pertains, such as visualizing the mapping site where a work order has been assigned via redirection to the map-viewing interface 501, following a review of any corresponding files within the file-viewing interface 502, such as by sorting pending work orders that may be in need of review.

The application 132 may further offer an option for the appearance of the mapping site, as visualized through the unified view display window 510 or as visualized with respect to an entirety of the map-viewing interface 501 (including a corresponding legend), being recorded as an image, PDF, or the like for creating a file corresponding to at least one configuration of the mapping site viewable via the map-viewing interface 501. That is, any combination of the display layers at any position or perspective relative to the mapping site may be utilized in creating the desired image corresponding to the appearance of the mapping site. Such an image may include the same information displayed via any combination of the features shown in FIGS. 3-5. Such an image may thus be printed to provide a hardcopy version of the data accessible via the application 132 when easy access to the application 132 is not available, or when an internet connection is not expected to be available.

The application 132, via use of the map-viewing interface 501 and the file-viewing interface 502, may be especially beneficial in organizing the activities of one of the agents 210 of the enterprise system 200 or one of the third-party service providers contracted or employed to perform tasks with respect to one or more mapping sites associated with the enterprise system 200. Each agent 210 or service providers having an account and appropriate access to the application 132 may be able to automatically receive notifications, such as emails or text messages, from the computing system 206 when certain requests or updates have been made with respect to a mapping site associated with the application 132. Such notifications may include a notification that a potential job has been added to the account of the agent/service provider, that a job has been assigned to the account of the agent/service provider, that an assigned job has been rescheduled or altered, that a new job (such as a work order document or file) has been shared to the account of the agent/service provider, that a new file (corresponding to any mapping site related file described herein) has been shared to the account of the agent/service provider, or that a new mapping site and/or sub-site (and permissions to access thereto) has been shared to the account of the agent/service provider. Each of these automatic notifications may result in an alert, sound, or signal evident to the agent/service provider to ensure that the notification is received and noted in due time, and especially where a time sensitive job request has been made (corresponding to a leak, damage, etc.). The application 132 may be utilized to allow the agent/service provider to accept or reject job requests, as applicable.

The ability to tag specific files, such as work orders, invoices, images pertaining to work performed, etc., that may be specifically beneficial in accessing a job to be performed, allows for such agents 210 or service providers to review the physical location at which the task in question has been requested prior to execution thereof, and even at the instant the request is first made. This can greatly reduce time and improve efficiency both in planning and executing such tasks, and/or in determining whether to accept or reject such tasks. For example, the agent/service provider can more easily ascertain the time and expense of a task where the mapping site is readily available for inspection via the available display layers and files, and can thus plan, schedule, estimate, and prioritize the order of assigned tasks more easily. Furthermore, when performing the task, the availability of the physical position of each feature within the corresponding unified view display window 510 provides an instant guide regarding where to perform such tasks with respect to certain structures and utilities shown with respect to the mapping site. The availability of tagged files at specific positions within the mapping site also provides a visual guide for the agent/service provider to quickly identify files associated with the same position, such as past repairs or maintenance to the same component at that location, to improve efficiency in completing the current task.

The manner in which all files and data associated with a specific mapping site can be organized within a single folder or file location also provides a benefit in that all documentation relevant to the management or maintenance of the mapping site may be stored digitally to a single location. There is accordingly never a concern relating to finding independently provided documentation of distinct systems or structures when performing a complex task involving multiple systems and structures.

The present invention has primarily been described in regards to two-dimensional graphical representations such as are found when viewing an overhead map, but it should be readily apparent to one skilled in the art that the concepts of the present invention may be applied to any viewing perspective, and may further be utilized in three-dimensional representations or renderings. For example, any objects that have a known depth/height in addition to a geo-position in GCS coordinates may be positioned at a desired three-dimensional position within a three-dimensional representation of the mapping site, including the use of a file tag at a specified three-dimensional position within the mapping site.

From the foregoing description, one ordinarily skilled in the art can easily ascertain the essential characteristics of this invention and, without departing from the spirit and scope thereof, can make various changes and modifications to the invention to adapt it to various usages and conditions.

I claim:

1. A computing system for displaying graphic content regarding a mapping site on a user device, the computing system comprising:
at least one processor;
a communication interface communicatively coupled to the at least one processor; and
a memory device storing executable code that, when executed, causes the processor to:
generate a map-viewing interface viewable on the user device, the map-viewing interface including a display window visually presenting at least one of one or more display layers associated with the mapping site therein, each of the display layers corresponding to a graphical representation of at least one structure and/or utility present at the mapping site, wherein each of the display layers is associated with geo-positional data to establish a relative position of each of the display layers within the display window; and
display a file tag within the display window of the map-viewing interface, wherein the file tag is associated with a file accessible to the computing system and including data relating to one of the structures and/or utilities present at the mapping site, wherein the file is associated with geo-positional data to establish a position of the file tag within the display window relative to each of the display layers instantaneously being visually presented within the display window.

2. The computing system of claim 1, wherein the file is associated with a task to be performed at a position within the mapping site corresponding to the geo-positional data associated with the file.

3. The computing system of claim 2, wherein the file is associated with a work order relating to the task to be performed, and wherein the task to be performed is performed with respect to one of the structures and/or utilities present disposed at or adjacent the position within the mapping site corresponding to the geo-positional data associated with the file.

4. The computing system of claim 1, wherein the file is associated with a previously performed task at a position within the mapping site corresponding to the geo-positional data associated with the file.

5. The computing system of claim 4, wherein the file is an image, video, or document having content relating to the previously performed task, and wherein the previously performed task was performed with respect to one of the structures and/or utilities disposed at or adjacent the position within the mapping site corresponding to the geo-positional data associated with the file.

6. The computing system of claim 1, wherein the executable code, when executed, further causes the processor to:
provide a selection to a user of the user device regarding which of the plurality of the display layers to display within the display window; and
reconfigure the display window to display only the selected ones of the plurality of the display layers following the selection of the user.

7. The computing system of claim 1, wherein at least one of the one or more display layers associated with the mapping site includes a graphical representation of a structure and/or utility disposed below a ground surface of the mapping site.

8. The computing system of claim 1, wherein at least one of the one or more display layers associated with the mapping site includes a graphical representation of a structure and/or utility sensed via a surface penetrating mapping process.

9. The computing system of claim 8, wherein the surface penetrating mapping process includes the use of a surface penetrating radar system.

10. The computing system of claim 8, wherein the surface penetrating mapping process is performed by an agent of a first entity managing the computing system.

11. The computing system of claim 1, wherein a first entity manages the computing system, and wherein at least one of the one or more display layers associated with the mapping site is derived from data acquired by an agent of the first entity during a mapping process performed by the agent with respect to the mapping site.

12. The computing system of claim 11, wherein at least one of the one of more display layers associated with the mapping site is derived from data acquired from a second entity independently of the mapping process performed by the agent of the first entity.

13. A method of graphically representing a mapping site on a user device, the method comprising the steps of:
mapping at least one structure and/or utility at the mapping site via the use of at least one sensing device, the mapping step performed by one or more agents of a first entity;
generating one or more first display layers, each of the first display layers corresponding to a graphical representation of at least one structure and/or utility that is derived from data acquired during the mapping step;
generating one of more second display layers, each of the second display layers corresponding to a graphical representation of at least one structure and/or utility that is derived from data originating from a second entity, wherein the data originating from the second entity is acquired from a process different from the mapping step;
editing one of the first display layers or one of the second display layers following a change to the mapping site, wherein the editing of each of the first display layers is restricted to be performed only by one of the agents of the first entity, and wherein the editing of each of the second display layers may be performed by one of the agents of the first entity or by the second entity; and
generating a display window on the user device following the editing step, the display window visually presenting at least one of the first display layers and/or at least one of the second display layers therein to graphically represent a condition of the mapping site following the editing step.

14. The method of claim 13, wherein at least one of the first display layers includes a graphical representation of a structure and/or utility disposed below a ground surface of the mapping site.

15. The method of claim 13, wherein at least one of the first display layers includes a graphical representation of a structure and/or utility sensed via a surface penetrating mapping process utilized during the mapping step.

16. The method of claim 13, wherein the second entity is one of a customer of the first entity, a service provider employed or contracted by the customer, or a service provider employed or contracted by the first entity.

17. A method of assigning a work order to a service provider comprising the steps of:
sending a notification to a user device of the service provider indicating the generation of the work order, the work order corresponding to a task to be performed at a mapping site, wherein the work order is associated with geo-positional data to establish a relative position of each of the display layers within the display window;
generating a display window on the user device of the service provider following the sending step, the display window visually presenting at least one of one or more display layers associated with the mapping site therein, each of the display layers corresponding to a graphical representation of at least one structure and/or utility present at the mapping site, wherein each of the display layers is associated with geo-positional data to establish a relative position of each of the display layers within the display window; and
tagging a position within the display window, relative to each of the display layers instantaneously visually presented therein, at which the task corresponding to the work order is to be performed based on the geo-positional data associated with the work order.

18. The method of claim 17, wherein the sending of the notification includes the user device of the service provider automatically signaling the receipt of the notification.

19. The method of claim 17, further comprising a step of displaying a file tag within the display window, wherein the file tag is associated with a file including data relating to one of the structures and/or utilities present at the mapping site, wherein the file is associated with geo-positional data to establish a position of the file tag within the display window relative to each of the display layers instantaneously being visually presented within the display window.

20. The method of claim 19, further comprising a step of redirecting the user device of the service provider to view the contents of the file upon an interaction of the service provider with the file tag displayed within the display window.
